(19) United States
(12) Patent Application Publication
(10) Pub. No.: US 2001/0020222 A1
(43) Pub. Date: Sep. 6, 2001

(54) System and method for manufacturing custom-made footwear using internet

(76) Inventors: Kun Woo Lee, Seoul (KR); San Kun Park, Kyung Ki-Do (KR); Byung Kyu Lee, Kyung Ki-Do (KR)

Correspondence Address: BACON & THOMAS, PLLC, 4th Floor, 625 Slaters Lane, Alexandria, VA, 22314-1176, US

(21) Appl. No.: 09/749,781

(22) Filed: Dec. 28, 2000

(30) Foreign Application Priority Data
Feb. 23, 2000 (KR) 14873

(51) Int. Cl. G01B 5/02

(52) U.S. Cl. 702/155; 702/158

(57) ABSTRACT

The custom-made footwear manufacturing system and method using Internet may rapidly and simply realize the footwear comfortable and suitable for a customer. The system includes, in a circumstance where the data transmission through Internet is possible, a shape measuring unit for extracting shape information of a customer foot, a data transmitting unit for transmitting the extracted shape information to a footwear manufacturer through Internet, a data receiving unit for receiving the transmitted data, a storage unit for storing the received shape information, a shoelast design unit to generate a 3-dimensional shape model of the custom-fitted shoelast suitable for the customer by extracting foot shape information of the customer from the storage unit, generating a 3-dimensional shape model of the foot and mixing it with the 3-dimensional shape model of the standard shoelast, a shoe upper cover pattern design unit for determining an shoe upper cover pattern, and a shoelast manufacturing unit for manufacturing the custom-fitted shoelast from its 3-dimensional shape model.

### BACKGROUND OF THE INVENTION

1. Technical field

The present invention relates to custom-made footwear manufacturing system and method using Internet, and more particularly to custom-made footwear manufacturing system and method using Internet for making comfortable footwear fast and simply.

2. Description of the Prior Art

Recently, departing from mass production, there are increased interests for order production to quickly cope with demands of the customers. Moreover, many studies for the order production system for effectively realizing the order production are also progressed.

In view of custom-made footwear, a shoe fashion design program, a standard shoelast design program, a shoe upper cover pattern design program, a shoe sole design program, etc. are commonly used for the automatic footwear manufacturing.

Among them, the shoelast is a very essential element to determine shape and size of the footwear. In other words, most footwear are made on basis of a shape of the shoelast.

Such shoelast is similar to a shape of a human foot and made of rigid materials such as wood and plastic. For making the shoelast, size of a foot, comfortableness, easiness for making and shoe style are considered.

In addition, because the shoelast is considered to be very difficult to design, design of the shoelast mostly depends on experiential knowledge of experts having sufficient experiences.

However, though the conventional footwear manufacturing techniques are quite automated in partial, there is no system to integrate overall processes of making the footwear. Therefore, it is, so far, somewhat difficult to manufacturing the footwear conveniently and fast at a low cost.

### SUMMARY OF THE INVENTION

The present invention is designed to overcome the problems of the prior art. An object of the invention is to provide custom-made footwear manufacturing system and method using Internet, which enables to make comfortable footwear rapidly and simply.

In order to accomplish the above object, the present invention provides a system for manufacturing custom-made footwear using Internet, including shape measuring means for extracting shape information of a foot of a customer; a data transmitting unit for transmitting the extracted shape information to a footwear manufacturer through Internet; a data receiving unit for receiving the data transmitted from the data transmitting unit; a storage unit for storing the shape information received in the data receiving unit; a shoelast design unit to generate a 3-dimensional shape model of the custom-fitted shoelast suitable for the customer by extracting foot shape information of the customer from the storage unit, generating a 3-dimensional shape model using the foot shape information, and mixing the 3-dimensional shape model with a standard shoelast 3-dimensional shape model; a shoe upper cover pattern design unit for determining a pattern of an upper cover of the shoe; and a shoelast manufacturing unit for manufacturing the shoelast using the custom-fitted 3-dimensional shape model generated by the shoelast design unit.

In order to obtain the above object, the present invention also provides a method of manufacturing custom-made footwear using Internet, including the steps of extracting shape information of foot of a customer; selecting style, fashion and color of the footwear desired by the customer; transmitting the customer-related information to a footwear manufacturer through Internet; receiving the transmitted customer-related information; storing the received customer-related information in storage means; generating a 3-dimensional shape model of the customer's foot by extracting the customer-related information from the storage means; generating a custom-fitted shoelast 3-dimensional shape model suitable for the customer by mixing the generated 3-dimensional shape model of the customer's foot with that of a standard shoelast 3-dimensional shape model; extracting a 2-dimensional shape model of a shoe upper cover pattern; manufacturing a custom-fitted shoelast using its 3-dimensional shape model; and manufacturing shoes suitable for the customer using the customized shoelast.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a block diagram showing overall configuration of a custom-made footwear manufacturing system using Internet according to the present invention;

FIG. 2 is a block diagram showing main elements of a shape measuring unit in the custom-made footwear manufacturing system of the present invention;

FIG. 3 is a diagram illustrating one embodiment of the shape measuring unit;

FIG. 4 is a flow chart illustrating a custom-made footwear manufacturing method using Internet according to the present invention;

FIG. 5 is a flow chart illustrating how to scan a standard shoelast and a customer foot in the step of extracting 3-dimensional shape information;

FIG. 6 is a diagram illustrating how to scan the foot or the shoelast using 4 slit beam lasers and cameras installed in the shape measuring unit;

FIG. 7 shows a coordinate system for illustrating the procedure of obtaining the 3-dimensional shape information;

FIG. 8a is a flow chart illustrating the procedure of generating a 3-dimensional shape model of the customer foot in the custom-made footwear manufacturing method;

FIG. 8b is a flow chart that illustrates how two different B spline curves in absolute coordinates are composed in the step of generating a 3-dimensional shape model for the customer foot;

FIG. 8c shows the shaded display of the 3-dimensional surface model of the shoelast and the customer foot;

FIG. 9 is a flow chart illustrating the step of generating a 3-dimensional shape model of the custom-fitted shoelast suitable for the customer by mixing the 3-dimensional shape model of the customer foot with that of the standard shoelast;

FIG. 10a is a flow chart illustrating how to reflect the effect of a height of a heel for the 3-dimensional shape model of the customer foot and that of the standard shoelast;

FIG. 10b is a diagram illustrating how to reflect the effect of the height of the heel onto the 3-dimensional shape model of the standard shoelast;

FIG. 10c is a diagram illustrating how to reflect the effect of the height of the heel onto the 3-dimensional shape model of the customer foot;

FIG. 11a is a flow chart illustrating how to mix the 3-dimensional shape model of the customer foot with that of the standard shoelast in the step of generating the 3-dimensional shape model of the custom-fitted shoelast;

FIG. 11b is a diagram showing a 3-dimensional shape model of the standard shoelast;

FIG. 11c is shows a 3-dimensional shape model of the customer foot;

FIG. 11d shows a 3-dimensional shape model obtained by mixing the customer foot and the standard shoelast;

FIG. 11e shows a weight distribution curve used in mixing the section curves;

FIG. 12a is a diagram illustrating one example of the shoe upper cover pattern;

FIG. 12b is a flow chart illustrating the step of extracting a 2-dimensional shape of the shoe upper cover pattern;

FIG. 13a is an illustration of a ruled surface approximated from a freeform shoe upper cover surface;

FIG. 13b is an illustration of a developable surface derived from the ruled surface; and

FIG. 13c is an illustration of a 2-dimensional surface pattern developed from for the developable surface.

### DETAILED DESCRIPTION OF THE PREFERRED EMBODIMENT

Hereinafter, preferred embodiments of the present invention will be described in detail with reference to the accompanying drawings.

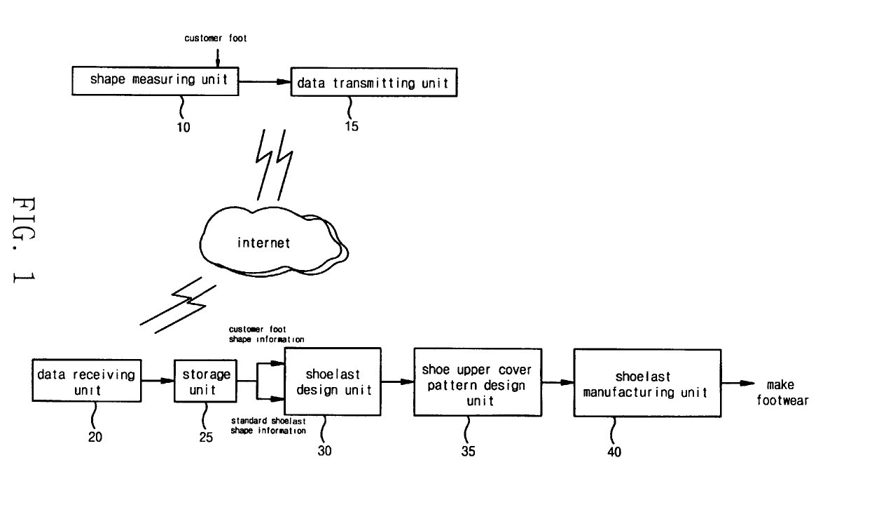

FIG. 1 is a block diagram showing overall configurations of the custom-made footwear manufacturing system using Internet proposed by the present invention.

As shown in FIG. 1, the system of the present invention includes a shape measuring unit 10 for extracting shape information of a foot of a customer, a data transmitting unit 15 for transmitting the extracted shape information from the shape measuring unit 10 to a footwear manufacturer through Internet, a data receiving unit 20 for receiving the data transmitted from the data transmitting unit 20, a storage unit 25 for storing the shape information received in the data receiving unit 20, a shoelast design unit 30 to generate a 3-dimensional shape model of the custom-fitted shoelast suitable for the customer by extracting the foot shape information of the customer from the storage unit 25, generating a 3-dimensional shape model of the foot and mixing it with a 3-dimensional shape model of the standard shoelast, a shoe upper cover pattern design unit 35 for determining a pattern of an upper cover of the shoe, and a shoelast manufacturing unit 40 for manufacturing the shoelast using the 3-dimensional shape model of the custom-fitted shoelast generated by the shoelast design unit 30.

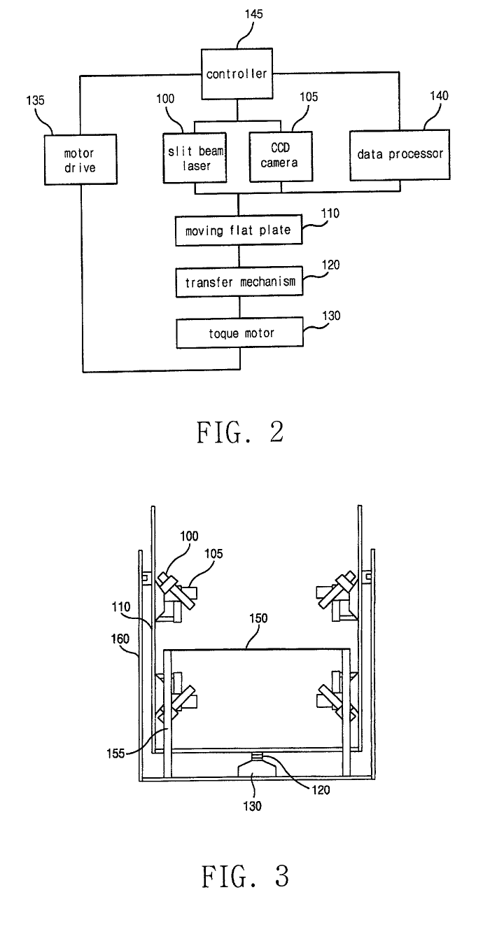

The shape measuring unit 10 scans an object and captures its image using CCD (charge coupled device) cameras and slit beam lasers and then extracts 3-dimensional shape information, which will be described with reference to FIG. 2 and FIG. 3.

FIG. 2 is a block diagram showing main elements of the shape measuring unit 10 and FIG. 3 shows the layout of the shape measuring unit 10.

The shape measuring unit 10 includes a slit beam laser 100 for scanning an object, a CCD camera 105 for capturing the image of the slit beams projected onto the object, a moving flat plate 110 connected to the slit beam laser 100 and the CCD camera 105 to move horizontally, a transfer mechanism 120 having a lead screw for moving the flat plate 110 horizontally, a torque motor 130 for supplying drive force to the transfer mechanism 120, a motor drive 135 for supplying power source to the torque motor 130, a data processor 140 for processing data from the slit beam laser 100 and the CCD camera 105, a controller 145 for controlling each unit, a flat glass plate 150 for positioning the object thereon, a flat glass plate support 155 for supporting the flat glass plate 155, and a protect case 160 for protecting each unit.

The slit beam laser 100 and the CCD camera 105 are assembled in one piece and there are provided four pieces of the slit beam lasers 100 and the CCD cameras 105. The pieces of the slit beam lasers 100 and the CCD cameras 105 are positioned at upper right and left and lower right and left of the moving flat plate 110, respectively.

Four pieces of the slit beam lasers 100 and the CCD cameras 105 have different usage, as described below.

At first, in order to measure a sole of the foot, a customer puts the foot on the flat glass plate 150. Then, two pieces of the slit beam lasers 100 and the CCD cameras 105 at the lower right and left of the shape measuring unit 10 capture a shape of the sole of the customer foot.

Then, in order to measure an upper surface of the foot, the two pieces of the slit beam lasers 100 and the CCD cameras 105 at the upper right and left of the shape measuring unit 10 capture a shape of the upper surface of the customer foot.

On the other hand, the transfer mechanism 120, the torque motor 125 and the motor drive 135 operate as follows.

The controller 145 controls the motor drive 135 to drive the torque motor 125 and rotation of the torque motor 125 is converted into linear motion of the transfer mechanism 120. At this time, the transfer mechanism 120 moves together with four pieces of the slit beam lasers 100 and the CCD cameras 105 attached to the moving flat plate 110.

If the moving flat plate 110 moves linearly, the four pieces of the slit beam lasers 100 and the CCD cameras 105 capture the image of projected beams as they scan the object on the flat glass plate 150 while moving to a length of the foot at regular intervals according to the linear motion of the moving flat plate 110.

The shoe upper cover pattern design unit 35 automatically designs 2-dimensional image of the shoe upper cover using the 3-dimensional shape model of the custom-fitted shoelast generated by the shoelast design unit 30.

In addition, the shoelast manufacturing unit 40 automatically fabricates the shoelast using the 3-dimensional shape model of the custom-fitted shoelast automatically generated by the shoelast design unit 30.

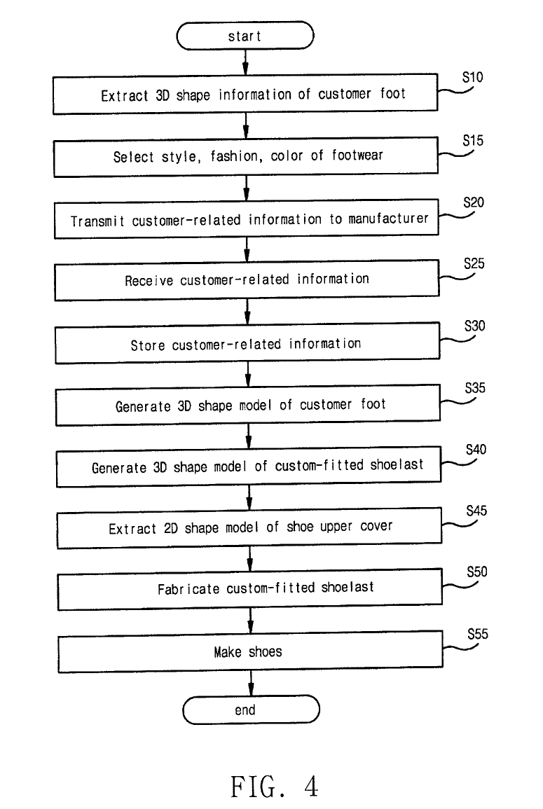

FIG. 4 is a flow chart illustrating the custom-made footwear manufacturing method using Internet according to the present invention.

As shown in the figure, the custom-made footwear manufacturing method using Internet includes the steps of extracting shape information of the customer foot S10, selecting style, fashion and color of the footwear desired by the customer S15, transmitting the customer-related information to the footwear manufacturer through Internet S20, receiving the transmitted customer-related information S25, storing the received customer-related information in the storage unit S30, generating a 3-dimensional shape model of the customer foot by extracting the customer-related information from the storage unit S35, generating the 3-dimensional shape model of the custom-fitted shoelast suitable for the customer by mixing the 3-dimensional shape model of the customer foot with that of the standard shoelast S40, extracting the 2-dimensional shape model of the shoe upper cover pattern S45, manufacturing the shoelast using the 3-dimensional shape model of the custom-fitted shoelast S50, and manufacturing shoes suitable for the customer using the custom-fitted shoelast S55.

In the step of extracting the shape information of the customer foot S10, the shape measuring unit 10 obtains the shape information by capturing the image of slit beams projected on the surface as the unit scans over the object.

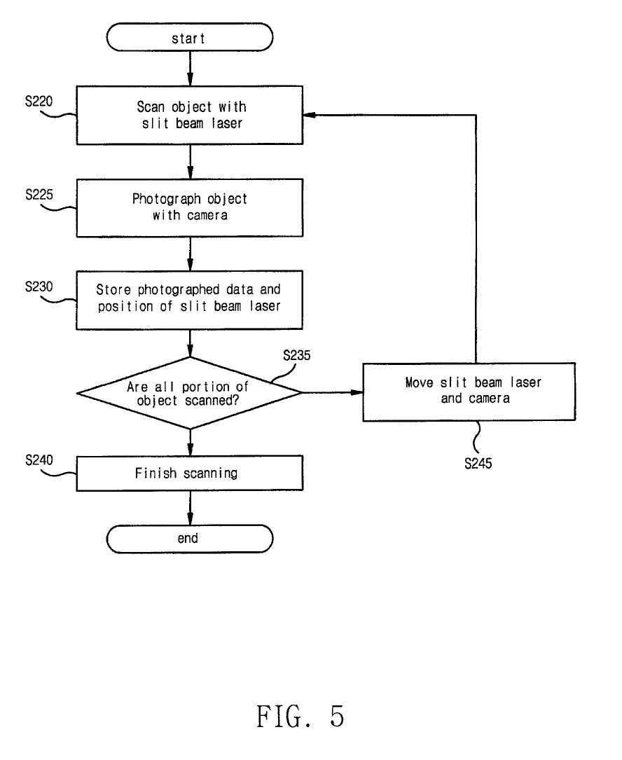

FIG. 5 is a flow chart illustrating the shape measuring unit 10 that photographs and scans the object in the step of extracting the shape information of the object in step S10.

As shown in the figure, the step S10 includes the steps of scanning the object using the slit beam laser S220, capturing the image of the slit beams projected onto the object using the camera S225, storing captured image data and a position of the slit beam lasers S230, checking whether all portions of the object are scanned S235, finishing the scanning in case that all portions of the object are scanned S240, and moving the slit beam laser and the camera in case that not all portions of the object are scanned S245.

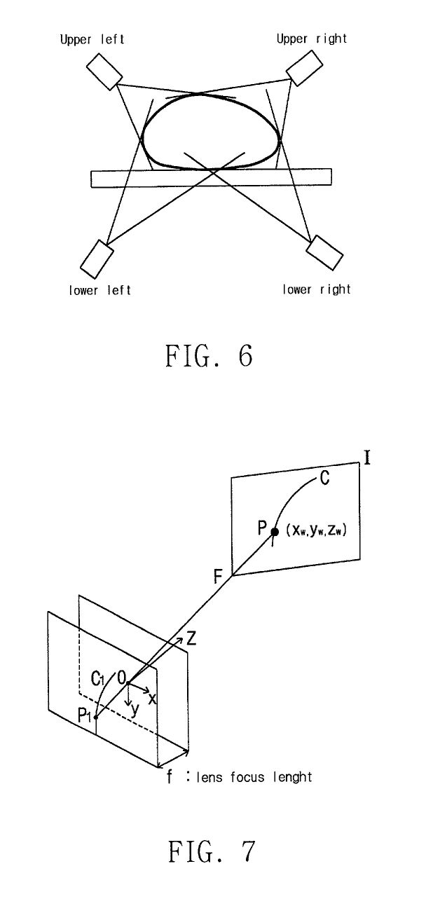

Each step of FIG. 5 is described below with reference to FIG. 6.

FIG. 6 is a diagram showing that the object is recognized as four different regions by four pieces of the CCD cameras and the slit beam lasers in the shape measuring unit 10 as they scan over the object and capture the slit beam image.

As shown in the figure, in order to obtain shape information of the object, that is, the standard shoelast or the customer foot, such four pieces of the slit beam lasers and the CCD cameras photograph and scan the object from upper right and left and lower right and left positions.

If the slit beam laser scans the standard shoelast or the customer foot from a certain position, a reflected slit beam generates a contour on a plane parallel to a x-y coordinate plane of the absolute coordinate system.

Then, the camera captures the contour image projected onto the standard shoelast or the customer foot. At this time, the camera points to the object from upper right and left and lower right and left positions.

Photographed image data and position data of the slit beam laser are used later in the step of processing image data.

After photographing and scanning, the camera and the slit beam laser move to the next positions and such process is repeated.

Here, the slit beam laser and the camera move in a z-direction of the absolute coordinate system, in which moving distances of the slit beam laser and the camera is set by a user.

As described above, because of scanning the object from four positions at the same time, the present invention may minimize area of the object not scanned.

In addition, if the user wants to extract shape information for a specific portion of the object, the user may obtain the partial shape information only by photographing and scanning the portion of the object. Therefore, the shape measuring unit 10 does not need to photograph and scan all surfaces of the object, which may prevent unnecessary image process.

FIG. 7 illustrates the step of obtaining a 3-dimensional shape information of the object.

As shown in the figure, when scanning the slit beam on the object, an image of a region reflecting the slit beam on the object appears bright, while an image of other region not reflecting the slit beam appears dark. In such images, the bright image may be extracted using a threshold operation. For obtaining 3-dimensional absolute coordinates from the image coordinates, the position data of the slit beam laser is used together with the image coordinates.

In the figure, a point P on a slit beam projected on the object has the location P1 in the image plane such that the lens center O is located between the line F connecting P and P1.

The equation of the line F corresponding to each image coordinate may be obtained with use of camera calibration and the equation of a plane I made by the slit beam may also be obtained with use of the position information of the laser, thus the intersection point of the line F and the plain I can be obtained and it provides the 3-dimensional absolute coordinates of a point on the surface of the object.

In the above, the process of extracting the shape information of the object with use of four pieces of the slit beam lasers and the CCD cameras positioned in upper right and left and lower right and left of the shape measuring unit 10 is explained.

Now, among the steps in the custom-made footwear manufacturing method using Internet shown in FIG. 4, the steps next to the step of extracting the shape information for the customer foot will be described again in detail.

In the step of selecting style, fashion, color, etc. of the footwear desired by the customer S15, the customer connects to a web site of the footwear manufacturer through Internet and then selects a desired one among various options provided by the manufacturer. For example, the customer may select features of the footwear such as shape, fashion, color, height of the heel, etc. as desired.

In the step of storing the received customer-related information in the storage unit S30, the customer-related information stored in the storage unit 25 is used for the future order also. Moreover, if sufficient shape information is stored, such information may be used to develop new standard shoelasts for mass production.

The storage unit 25 stores 3-dimensional shape information of various standard shoelasts from the manufacturer as well as the customer-related information from the customers. The footwear manufacturer extracts shape information of various standard shoelasts using the shape measuring unit 10 and then generates 3-dimensional shape models using the shape information to be stored in the storage unit 25.

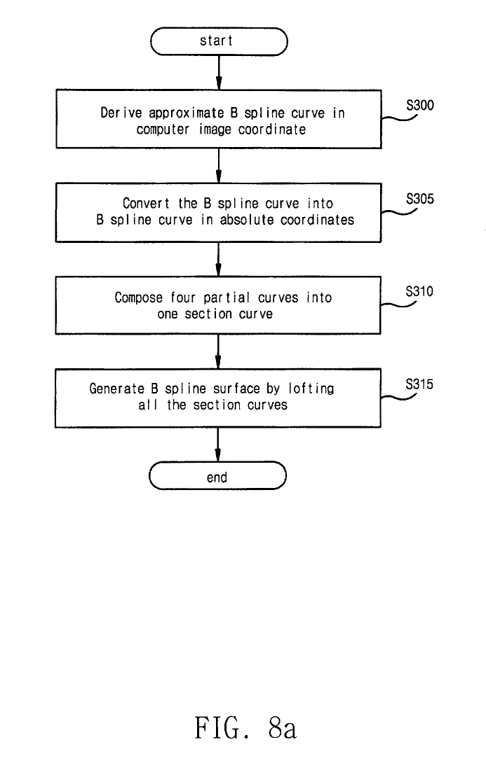

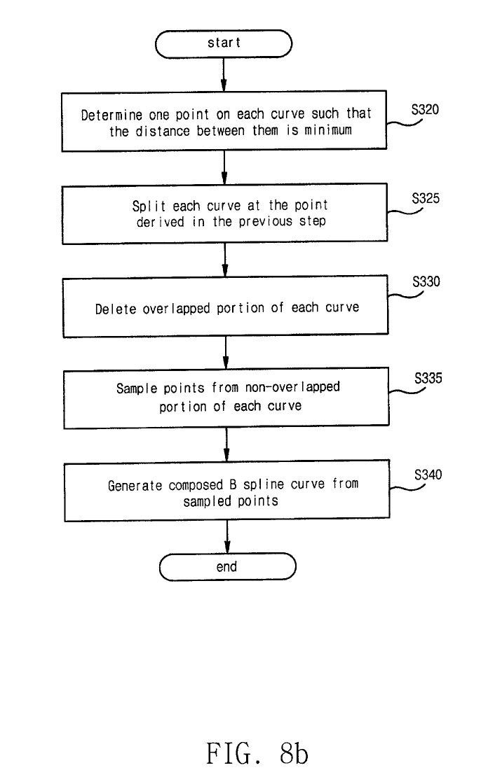

In addition, as shown in FIG. 8a, the step of extracting the customer-related information from the storage unit 25 and generating the 3-dimensional shape model of the customer foot S35 includes the steps of deriving a B spline curve in a computer image coordinates through the threshold operation S300, converting the B spline curve in the computer image coordinates into a B spline curve in the absolute 3-dimensional coordinates S305, composing four partial curves, each of which is the B spline curve in the absolute coordinates, to one section curve S310, and generating a B spline surface by lofting several section curves S315.

In the step of deriving the B spline curve in the computer image coordinates through the threshold operation S300, the shape information of the object stored in the storage unit 25, that is, the image data obtained by the shape measuring unit 10 and the position data of the corresponding slit beam laser are extracted.

When extracting data from the shape information of the object required to generate the 3-dimensional shape model, among pixels on the computer image, only pixels having higher luminance than a user-defined luminance, or a threshold value, of the slit beam reflected on the object are selected.

The B spline curve in the computer image coordinates is derived from a pixel cloud of the selected computer image.

At this time, because the slit beam has still bigger thickness than the computer image pixel, an approximate B spline curve is derived from the pixel cloud using the least square approximation method.

In the step of converting the B spline curve in the computer image coordinates into the B spline curve in the 3-dimensional absolute coordinates S305, the B spline curve in the computer image coordinates is converted into the B spline curve in the absolute coordinates with use of camera adjustment characteristics obtained in the camera calibration step and the position data of the slit beam laser.

At this time, the converted curve means four portions of the B spline curve in the absolute coordinates obtained from the image data photographed or scanned by four pieces of the shape measuring units 10.

Such four curves are composed into one closed curve. When composed into a closed curve, the curves are partially overlapped each other to make a closed curve.

FIG. 8b is a flow chart illustrating how to compose two B spline curves in the absolute coordinate.

As shown in the figure, the step of composing two B splines overlapping each other includes the steps of determining the point on each curve such that the distance between them is minimized S320, splitting each curve at the determined point S325, deleting an overlapped portion among split curves S330, sampling the points from non-overlapped portion of each split curve S335, and generating a composed curve through approximation from the sampled points S340.

FIG. 8c shows the B spline curves defining the 3-dimensional shape model of the shoelast and the customer foot.

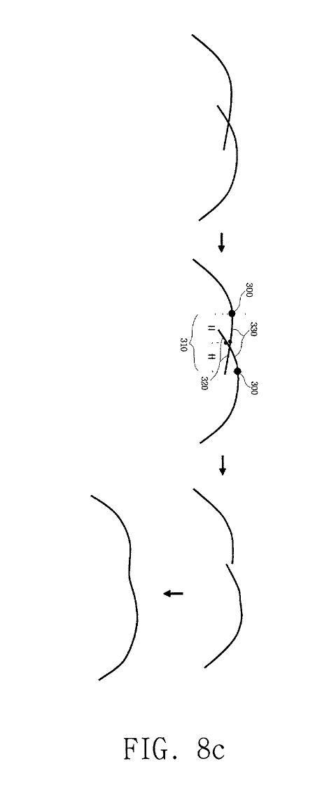

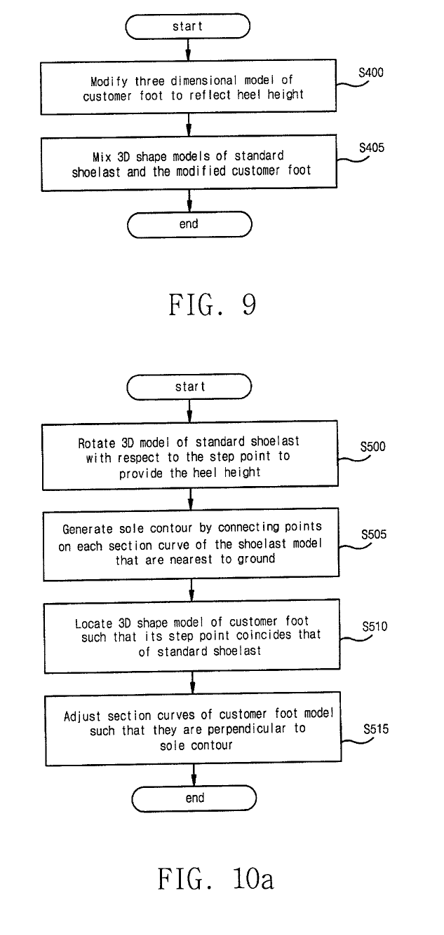

FIG. 9 is a flow chart for illustrating the step of generating a 3-dimensional shape model of a custom-fitted shoelast by mixing the 3-dimensional shape model of the customer foot with that of the standard shoelast.

As shown in the figure, the step of generating a 3-dimensional shape model of the custom-fitted shoelast S40 in FIG. 4 includes the steps of modifying the 3-dimensional shape model of the customer foot to reflect heel height effect S400, and mixing 3-dimensional shape model of the standard shoelast with that of the customer foot S405.

Now, the step of considering the heights of the heels for the 3-dimensional shape model of the standard shoelast and the customer foot S400 is described.

While the shape measuring unit 10 did not consider the height of the heel when measuring the standard shoelast and the customer foot, this step S400 executes an algorithm to make the standard shoelast and the customer foot have identical height of the heel.

Coinciding the heights of the heel for the standard shoelast and the customer foot is essential to mix each 3-dimensional shape model of the standard shoelast and the customer foot.

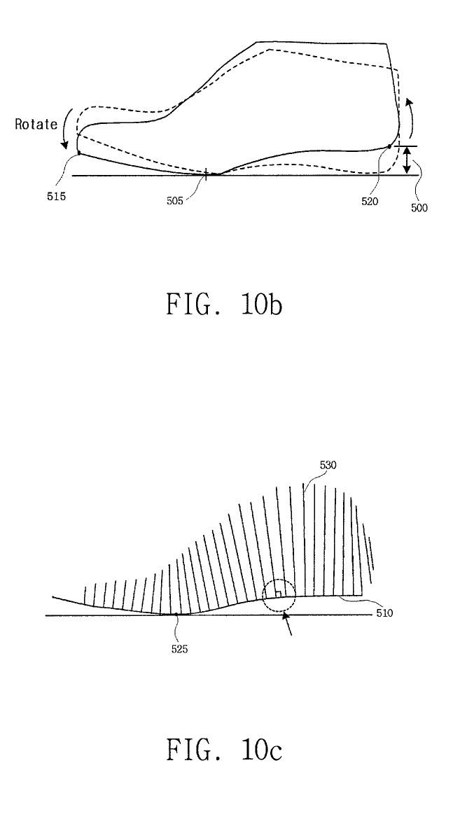

FIG. 10a is a flow chart for illustrating how to reflect the effect of the heel height onto the 3-dimensional shape model of the standard shoelast and the customer foot in the step S400.

As shown in the figure, the step S400 includes the steps of rotating the 3-dimensional shape model of the standard shoelast with respect to the step point to provide the heel height at the back S500, generating a sole contour by connecting points on each section curve of the shoelast model that are nearest to the ground S505, locating 3D shape model of the customer foot such that its step point coincides that of the shoelast model S510, and adjusting each section curve of the customer foot model such that each section curve is perpendicular to the sole contour S515.

FIG. 10b is a diagram illustrating how to apply the height of the heel to the 3-dimensional shape model of the standard shoelast and FIG. 10c is for how to apply the height of the heel to the customer foot model.

Referring to the figures, when applying the heel height 500 to the 3-dimensional shape model of the standard shoelast as in FIG. 10b, the standard shoelast model is just rotated with respect to the step point 505. However, in order to apply the heel height to the 3-dimensional shape model of the customer foot, more complex conversion is needed using the sole contour 510 derived from the 3-dimensional shape model of the standard shoelast.

Now, interactions between each step in FIG. 10a are explained with reference to FIG. 10b and FIG. 10c.

In the step of rotating the standard shoelast model with respect to the step point 505, S500, the standard shoelast model is rotated to provide the heel height 500 at the back using the step point 505 as a pivot point, as shown in FIG. 10b.

In addition, the step of generating the sole contour by connecting the section curves at the points nearest to the ground S505, as shown in FIG. 10b, connects the point on each section curve where each section curve is nearest to the ground from a shoelast head point 515 to a shoelast tail point 520 and then uses the generated curve as the sole contour 510 for the 3-dimensional shape model of the customer foot.

At this time, connecting points nearest to the ground means generating the B spline curve by interpolating each point and the resulting B spline curve becomes the sole contour.

In the step of coinciding the step point of the customer foot model and that of the standard shoelast model, it is really difficult to calculate the step point 525 of the 3-dimensional shape model. In order to calculate the step point 525 of the customer foot model, after projecting an image of a head point of the metatarsal bones of the sole, obtained by X-ray, onto the ground, such head point may be set as the step point. But, since it is somewhat not practical to obtain an X-ray picture of the customer foot, a statistical result is used.

In addition, the step of adjusting each section curve of the 3-dimensional shape model of the customer foot in order to make the sole contour perpendicular to the section curves of the customer foot model S515, as shown in FIG. 10c, is to readjust each section curve 530 of the customer foot 3-dimensional shape model to be perpendicular to the sole contour 510. At this time, the adjusted section curves 530 have irregular gaps therebetween.

Now, the step of mixing each 3-dimensional shape model of the standard shoelast and the customer foot S405 in FIG. 9 is described below.

Mixing the 3-dimensional shape models of the standard shoelast and the customer foot is one of essential procedures to realize the custom-made footwear of the present invention. The step S405 composes characteristics of the customer foot 3-dimensional shape model and the standard shoelast 3-dimensional shape model, respectively.

The 3-dimensional shape model of the custom-fitted shoelast generated in the step S405 provides a shoelast approximating the shape of the customer foot, which ensures comfort for the customer. At this time, aesthetic sense may be endowed to the 3-dimensional shape model of the shoelast.

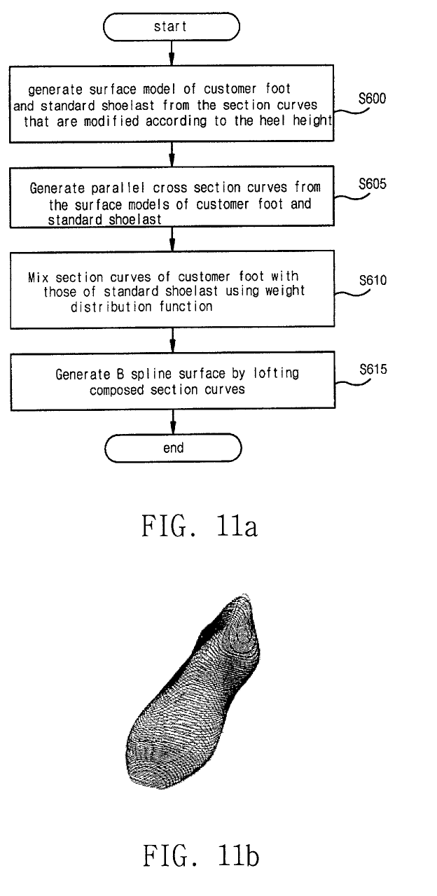

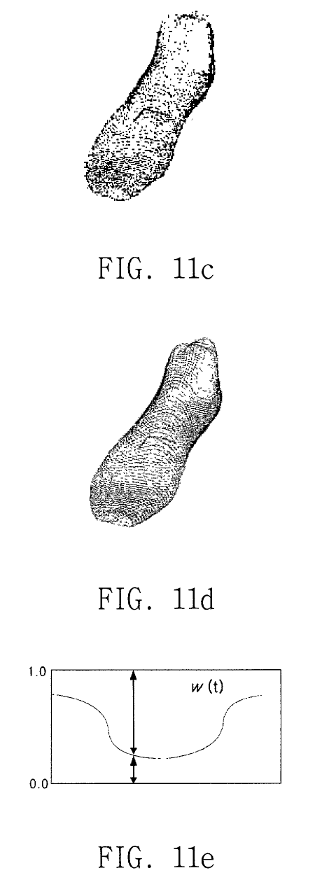

FIG. 11a is a flow chart illustrating how to mix the 3-dimensional shape model of the customer foot with that of the standard shoelast in the step of generating the 3-dimensional shape model of the custom-fitted shoelast.

As shown in the figure, the step of mixing the 3-dimensional shape model of the customer foot with that of the standard shoelast includes the steps of generating a surface model of the customer foot and a surface model of the standard shoelast using each section curve of the customer foot and the standard shoelast, which have been modified according to the height of the heel, S600, generating parallel cross sectional curves having regular gap from the surface models of the customer foot and the standard shoelast S605, mixing the section curves of the customer foot with those of the standard shoelast using the weight distribution function S610, and generating the B spline surface by lofting each composed section curve S615.

The step of generating the surface models of the customer foot and the standard shoelast from the section curves of the customer foot and the standard shoelast, to which the heel height is already applied S600, generates each surface model of the customer foot and the standard shoelast using the section curves that have been adjusted to reflect the heel height effect in the step S400.

In addition, the step of generating the regular and parallel section curves of the customer foot and the standard shoelast is illustrated in FIG. 11b and FIG. 11c.

FIG. 11b shows a 3-dimensional shape model of the standard shoelast with the parallel cross sections, and FIG. 11c shows a 3-dimensional shape model of the customer foot with the parallel cross sections at the same interval.

In the step of mixing each section curve of the customer foot and the standard shoelast using the weight distribution function S610, the weight distribution function is predetermined by the system and used to mix the two section curves, that is, the section curve of the customer foot and the section curve of the standard shoelast appropriate for the customer foot.

At this time, each section curve is arranged in z-direction in the absolute coordinate.

FIG. 11d shows a 3-dimensional shape model that results from the mixture of the customer foot model and the standard shoelast model, and FIG. 11e shows a weight distribution curve for the mixture.

The B spline curve generated by the mixture is given by the following formula.

Formula 1

C_{mixed}(t)=w(t)C_{Last}(t)+(1−w(t))C_{Foot}(f)

where C_{Last}(t) is the parametric equation of the section curve of the standard shoelast, C_{Foot}(t) is that of the section curve of the customer foot, C_{mixed}(t) is the section curve of the composed 3-dimensional shape model, and w(t) is the weight distribution curve.

At this time, the weight distribution curve may be adjusted for comfort and aesthetic aspect of the footwear.

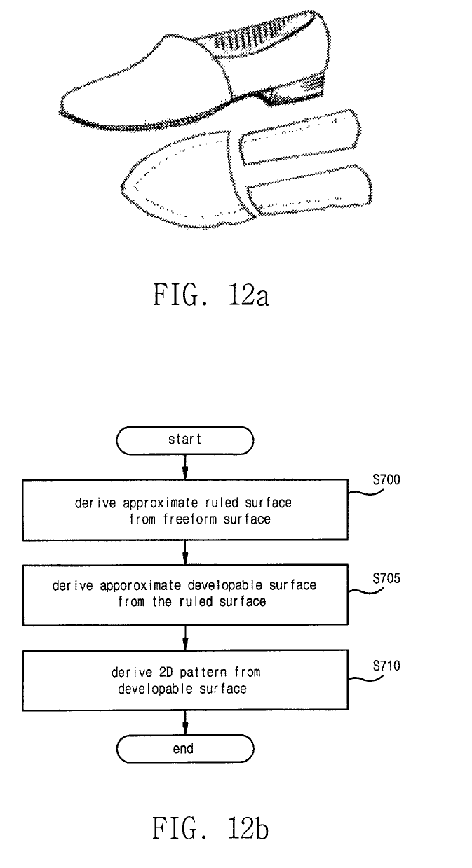

FIG. 12a is a diagram illustrating one example of the shoe upper cover.

As shown in the figure, the shoe upper is made of several parts of leather. In order to make the shoe upper, a workman makes the shoe upper by designing each part of leather and sewing the leather according to the design on basis of his experiences.

FIG. 12b is a flow chart illustrating the step of extracting a 2-dimensional shape of the shoe upper pattern.

As shown in the figure, the step of extracting the 2-dimensional shape includes the steps of deriving an approximate ruled surface from a freeform surface S700, deriving an approximate developable surface from the ruled surface S705, and deriving the 2-dimensional surface pattern from the developable surface S710.

The step of deriving the 2-dimensional pattern for the shoe upper partially employs the two-stage surface approximation scheme proposed by Elber. Elber's scheme has two steps; approximation of the freeform surface into a ruled surface, approximation of the ruled surface into a developable surface.

Each step in FIG. 12b interacts as follows.

The step of approximating the freeform surface into the ruled surface S700 employs Elber's scheme. That is, if the B spline surface is given, the ruled surface may be obtained by projecting each control point for a base curve having identical characteristics along a line connecting the control points.

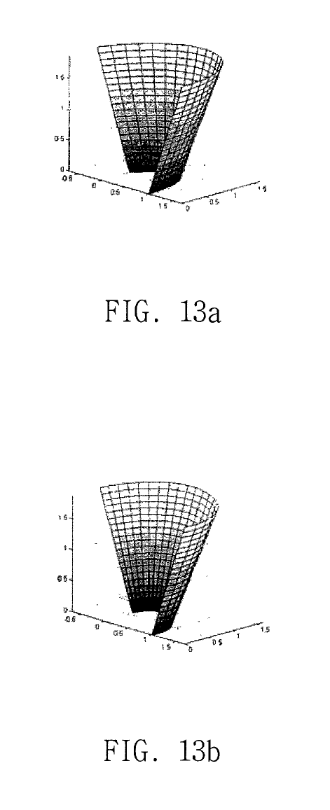

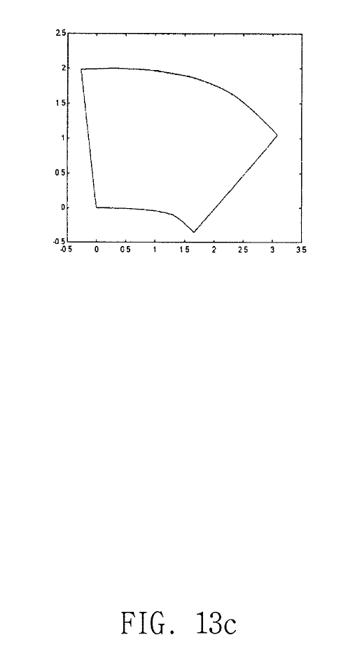

FIG. 13a shows the approximated ruled surface for the shoe upper surface.

Now, the step of deriving the approximate developable surface from the ruled surface is described with reference to FIG. 13a.

In view of formularizing the developed curve problem by optimal control, if a regular curve b(t) on a unit sphere corresponding to a one-parameter family of rulings and two base curve end points a₀, a₁ K R³ are given, the base curve a(t) is given to satisfy a(t₀)=a₀, a(t₁)=a₁, while if a result surface is f(s, t), f(s, t)=a(t)+s·b(t) and is developable.

In addition, as for the optimal control problem, to formularize the base curve design problem and to approximate an absolute ruled surface into the developable surface are described below.

At first, basic principles of the developable surface are as follows. a(t) is a regular curve in the reference sphere R³, b(t) is a differentiable curve in the reference sphere R³, and ||b(t)||=1 for all t; here ||·|| means standard Euclidean norms. Curves of a(t) and b(t) are defined over some interval [t₀, t₁].

The parameterized surface, or the ruled surface, is given by the following formula.

Formula 2

f(s,t)=a(t)+s·b(t), t∈[t₀,t₁·, ∈R

where a(t) is the base curve and the line passing through a(t) that is parallel to b(t) is called the ruling of the surface f at a(t).

In addition, the ruled surface f(s, t) is developable if satisfying the following formula.

Formula 3

<aₜ,b×bₜ>=0

where <·,·> denotes the Euclidean inner product in the reference sphere R³.

The condition of formula 3 is equivalent to the statement that ₐ^{·} must always lie in the plane spanned by b and _{b}^{·}. That is

In addition, the following formula shows a condition that the ruled surface f(s, t) is developable.

Formula 4

<ₐ^{·},b×_{b}^{·}>=0

At this time, the formula 4 means ₐ^{·} always exists on the plane spanned by ^{b,} _{b}^{·}.

In other word, the following formula is satisfied for some scalar functions u₁(t), u₂(t).

Formula 5

ₐ^{·}(t)=b(t)u₁(t)+_{b}^{·}(t)u₂(t)

As described above, by recasting the base design problem in above form, it may be understood that the ruled surface can be approximated into the developable surface if the ruled curve b(t) is not a geodesic.

Next, the optimal control approach to optimal surface approximation is described.

To generate the shoe-upper pattern, we can construct an objective function whose solution finds the best developable surface approximation to a given ruled surface.

In the ruled surface r(s, t)=c(t)+s·b(t), c(t) is a base curve, b(t) is a ruling, and t and s are selected in the range of t₀ “t”t₁, 0“s” L.

At this time, the developable surface approximated for the ruled surface may be obtained with use of the following objective function.

$$\frac{1}{2} {\int }_{{t}_{0}}^{{t}_{1}} {\int }_{0}^{L} {‖ f ( s , t ) - r ( s , t ) ‖}^{2} ⅆ s ⅆ t \qquad \text{Formula 6}$$

In other words, in the developable surface f(s, t)=a(t)+s·b(t) minimizing the formula 6, a final developable surface can be obtained by calculating the reference a(t).

At this time, the base curve a(t) satisfie _{α(t)}^{·}=B(t)u(t) and, end point conditions are a(t₀)=a₀ and a(t₁)=a₁.

In addition, the formula 6 shows that the rulings of the developable surface coincide with those of the ruled surface at the base curve end points t=t₀ and t=t₁.

Moreover, the object function of the formula 6 may be reduced as follows.

$$\frac{1}{2} {\int }_{{t}_{0}}^{{t}_{1}} {‖ a ( t ) - c ( t ) ‖}^{2} ⅆ t \qquad \text{Formula 7}$$

At this time, if applying the formula 7 as the objective function, it will do for singular arc. However, because Huu=0, the optimal control typically contains discontinuity, which may cause the surface discontinuity.

In order to avoid such singular arc problem, the objective function is set as the next formula.

$$\frac{1}{2} {\int }_{{t}_{0}}^{{t}_{1}} {\int }_{0}^{L} α {‖ f ( s , t ) - r ( s , t ) ‖}^{2} + β ( {‖ {f}_{t} ( s , t ) - {r}_{t} ( s , t ) ‖}^{2} + {‖ {f}_{s} ( s , t ) - {r}_{s} ( s , t ) ‖}^{2} ) ⅆ s ⅆ t \qquad \text{Formula 8}$$

At this time, the above formula 8 may be reduced as follows.

Formula 9

$$\frac{1}{2} {\int }_{{t}_{0}}^{{t}_{1}} α {‖ a ( t ) - c ( t ) ‖}^{2} + β {‖ {a ( t )}^{*} - {c ( t )}^{*} ‖}^{2} ⅆ t$$

At this time, α, β are weighting factors in the formula 8. Therefore, the optimal base curve a(t) can be obtained by solving a linear two-point boundary value problem.

By such processes, it is possible to design the developable surface and to develop the designed surface on a plane because the isometric mapping is possible between the developable surface and the plane.

Using the fact that a curve on the isometric surfaces have the same geodesic curvatures, the flat-pattern may be easily obtained.

FIG. 13b shows the developable surface approximated to the ruled surface.

FIG. 13c shows the 2-dimensional pattern for the developable surface.

As described above, the present invention includes, in circumstances of possibly transmitting data through Internet, the shape measuring unit for extracting the shape information of the customer foot, the data transmitting unit for transmitting the extracted shape information to the footwear manufacturer through Internet, the data receiving unit for receiving the data transmitted from the data transmitting unit, the storage unit for storing the shape information received in the data receiving unit, the shoelast design unit to generate the 3-dimensional shape model of the custom-fitted shoelast by extracting the customer foot shape information from the storage unit, generating the 3-dimensional shape model of the customer foot using the foot shape information, and mixing it with the 3-dimensional shape model of the standard shoelast, the shoe upper cover pattern design unit for determining a pattern of the shoe upper cover, and a shoelast manufacturing unit for manufacturing the custom-fitted shoelast using the 3-dimensional shape model of the custom-fitted shoelast generated by the shoelast design unit. All these elements enable a rapid and easy manufacturing of comfortable footwear for the customer.

In addition, the present invention may automatically manufacture the shoelast, which has been made only by experts having sufficient experiences, by storing the shape information of the custom-fitted shoelast in the storage unit and then using the shape information later.

Moreover, the present invention makes it possible to automatically design the 2-dimensional pattern for the shoe upper cover, which has been designed only by experts.

Furthermore, the present invention may reduce manufacturing costs of the footwear and may exclude inventories because the footwear is custom-made.

Besides, because the customer may select a desired style of the footwear, the present invention may provide the footwear satisfying the customer's desire.

The present invention also eliminate the redundant process for the customer in purchasing the footwear again by reusing the information related to the customer foot stored in the storage unit later.

The custom-made footwear manufacturing system and method according to the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A system for manufacturing custom-made footwear using Internet, comprising:
a shape measuring unit for extracting shape information of foot of a customer;
a data transmitting unit for transmitting the extracted shape information to a footwear manufacturer through Internet;
a data receiving unit for receiving the data transmitted from the data transmitting unit;
a storage unit for storing the shape information received in the data receiving unit;
a shoelast design unit to generate a 3-dimensional shape model of the custom-fitted shoelast suitable for the customer by extracting foot shape information of the customer from the storage unit, generating a 3-dimensional shape model of the foot shape, and mixing the 3-dimensional shape model of the foot with that of a standard shoelast;
a shoe upper cover pattern design unit for determining a pattern of an upper cover of the shoe; and
a shoelast manufacturing unit for manufacturing the shoelast using the 3-dimensional shape model of the custom-fitted shoelast generated by the shoelast design unit.

2. The system as claimed in claim 1,
wherein the shape measuring unit includes four slit beam lasers and cameras for photographing and scanning an object in four different directions in order to minimize the unrecognized portion.

3. A method of manufacturing custom-made footwear using Internet, comprising the steps of:
extracting shape information of the customer foot;
selecting style, fashion and color of the footwear desired by the customer;
transmitting the customer-related information to a footwear manufacturer through Internet;
receiving the transmitted customer-related information;
storing the received customer-related information in a storage unit;
generating a 3-dimensional shape model of the customer foot by extracting the customer-related information from the storage unit;
generating a 3-dimensional shape model of the custom-fitted shoelast suitable for the customer by mixing the 3-dimensional shape model of the customer foot with that of a standard shoelast;
extracting a 2-dimensional shape model of a shoe upper cover pattern;
manufacturing a shoelast using the 3-dimensional shape model of the custom-fitted shoelast; and
manufacturing shoes suitable for the customer using the custom-fitted shoelast.

4. The method as claimed in claim 3, wherein the step of extracting the shape information includes the steps of:
scanning an object using a slit beam laser;
capturing the image of the slit beams projected onto the object using a camera;
storing photographed data and a position of the slit beam laser;
checking whether all portions of the object are scanned;
finishing the scanning if all portions of the object are scanned; and
moving the slit beam laser and the camera if not all portions of the object are scanned.

5. The method as claimed in claim 3, wherein the step of generating the 3-dimensional shape model of the customer foot includes the steps of:
deriving a B spline curve in the computer image coordinates;
converting the B spline curve in the computer image coordinates into a B spline curve in the absolute coordinates;
composing four portions of the converted B spline curve in the absolute coordinates into a profile curve; and
generating a B spline surface by lofting all the profile curves.

6. The method as claimed in claim 3, wherein the step of generating the 3-dimensional shape model of the custom-fitted shoelast suitable for the customer comprises the steps of:
applying the heel height to the 3-dimensional shape model of the shoelast and the customer foot; and
mixing the 3-dimensional shape model of the standard shoelast with that of the customer foot.

7. The method as claimed in claim 6, wherein the step of applying the heel height to the standard shoelast model and the customer foot model comprises the steps of:
rotating the 3-dimensional shape model of the standard shoelast with respect to the step point to provide a heel height at the back;
generating a sole contour by connecting points on each section curves of the shoelast model that are nearest to the ground;
locating the 3-dimensional shape model of the customer foot such that its step point coincides the step point of the standard shoelast; and
adjusting each section curve of the customer foot model such that the section curve is perpendicular to the sole contour.

8. The method as claimed in claim 6, wherein the step of mixing the 3-dimensional shape model of the standard shoelast with that of the customer foot comprises the steps of:
generating a surface model of the customer foot and the standard shoelast from the section curves that are modified according to the heel height;
generating parallel cross section curves in a uniform gap from the surface models of the customer foot and the standard shoelast;
mixing each section curve of the customer foot with that of the standard shoelast using a weight distribution function; and
generating the B spline surface by lofting all the composed section curves.

9. The method as claimed in claim 3, wherein the step of extracting the 2-dimensional shape model for the shoe upper cover pattern comprises the steps of:
deriving an approximate ruled surface from a freeform surface;
deriving an approximate developable surface from the ruled surface; and
deriving the 2-dimensional surface pattern from the developable surface.
